(19) United States
(12) Patent Application Publication
(10) Pub. No.: US 2005/0096411 A1
(43) Pub. Date: May 5, 2005

(54) POLYURETHANE ADHESIVE FOR MASONRY CONSTRUCTION

(75) Inventor: ABUL HASHEM MOLLA, TROY, MI (US)

Correspondence Address: HARNESS, DICKEY & PIERCE, P.L.C., P.O. BOX 828, BLOOMFIELD HILLS, MI, 48303, US

(73) Assignee: ILLINOIS TOOL WORKS INC., GLENVIEW, IL (US)

(21) Appl. No.: 10/904,069

(22) Filed: Oct. 21, 2004

Related U.S. Application Data
(60) Provisional application No. 60/516,085, filed on Oct. 31, 2003.

(51) Int. Cl. C08K 9/10; C08K 3/34

(52) U.S. Cl. 523/210; 524/492

(57) ABSTRACT

A structural adhesive for masonry of a polyurethane adhesive base with dispersed thermal stabilizer particulate additive of a mean particle size sufficient for providing, after application and curing, cured structural adhesive thermal stability in favorable accordance to a predefined threshold. The polyurethane base provides at least 85 weight percent of the structural adhesive at a viscosity sufficient for room temperature bead application of the structural adhesive.

This application is based upon U.S. Provisional Application having Ser. No. 60/516,085 and filed on Oct. 31, 2003.

The present invention relates to masonry, adhesives for masonry, methods for making the adhesives, and the construction of the masonry.

Masonry construction has traditionally proceeded with application of mortar to a surface of a masonry unit such as a block or brick, positioning a surface of another masonry unit snuggly against the mortared surface, and then waiting for the mortar to cure. After the mortar cures, the mortared space between the two surfaces is usually denoted as a joint in the masonry. Mortar is usually prepared at or near a masonry construction site and hand-troweled into position. The overall process is time-consuming as periods of time are needed for each of the operations of positioning the masonry units, troweling the mortar, and curing the mortar to desired strength.

Synthetic polymeric materials such as polyurethane and epoxy have been used in mortar formulations with benefits in diminishing preparation time, application time, and curing time. But many of these formulations must be prepared at or near the construction site so that the mortar does not cure or otherwise modify in its properties prior to use in the masonry. Furthermore, many of these formulations are relatively expensive.

Frequently, cured mortar must enable conformance of masonry (or other related constructs such as a composite of paneling and masonry) in which it has been used to a set of construction standards, such as ASTM E119-00a, “Standard Test Methods for Fire Tests of Building Construction and Materials” and ASTM E 72-95, “Standard Test Methods Of Conducting Strength Tests For Panels For Building Construction.” A further performance challenge in mortar formulating is in formulation consistency insofar as day to day batch preparation of masonry adhesive and/or mortar inherently creates a basis for differentiated batch to batch quality in the collective mortar used on a masonry work.

What is needed is a masonry adhesive favorably assisting the resolution of both the above issues and other needs related to cost, performance, batch quality consistency, construction time, cure time, and tradesperson technical skill in the construction of high quality masonry. This invention is directed to solving one or more of these needs.

The invention provides a structural adhesive for masonry with a polyurethane adhesive base with dispersed thermal stabilizer particulate additive of a mean particle size sufficient for providing, after application and curing, cured structural adhesive thermal stability in favorable accordance to a predefined threshold. The base provides at least about 85 weight percent of the structural adhesive at a viscosity sufficient for room temperature bead application of the structural adhesive.

More specifically, the invention provides a structural adhesive for masonry, comprising:
(a) a polyurethane adhesive base, said base providing at least 85 weight percent of said structural adhesive at a viscosity sufficient for room temperature bead application of said structural adhesive; and
(b) thermal stabilizer particulate additive dispersed throughout said adhesive base, said particulate additive having a mean particle size sufficient for providing, after application and curing, cured structural adhesive thermal stability in favorable accordance to a predefined threshold.

In one aspect, the polyurethane base is an isocyanate-polyol reaction product prepolymer with additives of an optional plasticizer such as 1,2-propanediol cyclic carbonate, polydimethylsiloxane defoamer, (optional) benzoyl chloride, and an appropriate tertiary amine catalyst such as 4,4′-dimorpholinodiethylether. The isocyanate-polyol reaction product prepolymer provides about 13 percent free NCO. The isocyanate-polyol reaction product prepolymer is reacted, in one aspect of the invention, from isomeric methylenebis(phenyl isocyanate), polymethylene polyphenylisocyanate, hydroxy terminated poly(oxyalkylene)diol, and hydroxy terminated poly(oxyalkylene)triol.

In a further aspect of the invention, the thermal stabilizer particulate additive comprises either surface treated fumed silica particulate having a mean particle size of about 7 to about 16 nm, or calcium carbonate particulate having a mean particle size of about 0.07 to about 0.7 microns.

In yet a further aspect, the polyurethane base is preferably an isocyanate-polyol reaction product prepolymer having a free NCO percent of from about 10.5 to about 19.6 as reacted from (on the basis of the prepolymer) from about 35 to about 70 weight percent of isocyanate precursor and a remainder of hydroxy terminated polyol precursor. The isocyanate precursor is isomeric methylenebis(phenyl isocyanate), polymethylene polyphenylisocyanate having an isocyanate functionality of between 2.1 and 3, or a combination of these; and the hydroxy terminated polyol precursor is hydroxy terminated poly(oxyalkylene)polyol having a hydroxyl functionality of between 2 and 4, polyester polyol having a hydroxyl functionality of between 2 and 3, or a combination of these.

In a further aspect, the tertiary amine catalyst is from about 0.5 to about 1.5 weight percent of 4,4′-dimorpholinodiethylether, from about 0.05 to about 0.5 weight percent of bis(2-dimethylaminoethyl)ether, or a combination of these two catalysts.

In yet a further aspect, an optional plasticizer is added to the adhesive where the plasticizer is an adipate, a pthalate, a benzoate, a cyclic carbonate, or a combination of these.

The invention also includes the blending of components of the adhesive composition; adhesives made by a process of such blending; construction of masonry through use of the adhesive; and masonry constructed by using a daubing of the adhesive to bond masonry units selected from the group of masonry units consisting of a stone, a brick, a block, a tile, a rock, a pebble, and combinations thereof.

Further areas of applicability of the present invention will become apparent from the detailed description provided hereinafter. It should be understood that the detailed description and specific examples, while indicating the embodiments of the invention, are intended for purposes of illustration only and are not intended to limit the scope of the invention.

The following definitions and non-limiting guidelines must be considered in reviewing the description of this invention set forth herein.

The headings (such as “Introduction” and “Summary”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations the stated of features.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

In overview, the present invention provides convenient polyurethane adhesive for direct application to masonry as a replacement for traditional mortar. The polyurethane adhesive is applied as a daubing of from about 0.065 to about 0.750 inches in thickness (preferably from about 0.125 to about 0.750 inches in thickness) to a surface of a masonry unit (for example and without limitation, a block) to be bonded. The daubing is, in one embodiment, a bead (or caulking) of deposited adhesive; in another embodiment the daubing is a smoothed (or troweled) layer of adhesive; and, in yet another embodiment, the daubing is a randomly interspersed set of adhesive material microfilaments generally conforming to a webform. The open time (or work time) of the polyurethane adhesive enables multiple block surfaces to receive an application of the polyurethane adhesive prior to curing. In one embodiment, the polyurethane adhesive is applied from squeeze tubes. In an alternative embodiment, a pump (or pressurized canister) supplies the polyurethane adhesive to a dispensing wand (or “gun”) via a hose (which may be heated or unheated depending upon, for example, the environment of the construction project).

Compositionally, the product adhesive substantially (greater than about 85 weight percent of the final product adhesive) comprises polyurethane. Preferred additives include a tertiary amine catalyst, a defoamer (additive to suppress foam formation during curing), an (optional) inhibitor, an (optional) plasticizer, and a dispersed thermal stabilizer in particulate form. While the catalyst, defoamer, and inhibitor are essentially soluble in the product adhesive, the dispersed thermal stabilizer is provided in particulate form; in some embodiments, the dispersed thermal stabilizer particulate has a surface/volume ratio conformant to a nanofiller additive. In all embodiments, the particulate size of the thermal stabilizer is sufficiently large to impart thermal stability in favorable accordance to a predefined threshold (as, for example, defined in a quality test such as ASTM E119-00a, “Standard Test Methods for Fire Tests of Building Construction and Materials”) while, at the same time, being sufficiently small to enable the thermal stabilizer to remain well-dispersed throughout the polyurethane adhesive from the time that the polyurethane adhesive has been manufactured until the polyurethane adhesive has been cured. In other words, the thermal stabilizer is of large enough particulate size to provide robust performance of the cured adhesive under thermal stress while being small enough to not precipitate (respective to the viscosity of the polyurethane adhesive) to the point where the adhesive becomes fluidly layered or otherwise internally differentiated in its effective thermal stability properties. For a particular thermal stabilizer, this requires the derivation of an optimum particle size in the context of the viscosity of the polyurethane adhesive, the thermal stability performance requirements of the polyurethane adhesive, and the thermal stability efficacy of the particular thermal stabilizer. The thermal stabilizer therefore functionally provides compositional robustness of the adhesive under thermal stress (especially at temperatures and heating conditions above ambient temperature). In this regard, the thermal stabilizer is efficacious in stabilizing the adhesive at temperatures above ambient as derived from conductive, convection, or radiant heat transfer against the curing or cured adhesive; the thermal stabilizer is also efficacious in stabilizing the adhesive at temperatures above ambient derived from conductive, convection, or radiant heat transfer against the cured adhesive in the presence of an oxidizing agent, such as established when a direct flame (such as that derived from a Bunsen Burner) is effected against a surface of the cured adhesive.

In one embodiment, the tertiary amine catalyst is 4,4′-dimorpholinodiethylether, bis(2-dimethylaminoethyl)ether, or a combination of these. The catalyst is generally provided in an efficacious percentage in the final adhesive so that the adhesive will cure in a reasonable time under the conditions of application. Defoamer is also accordingly provided in an efficacious percentage in the final adhesive so that the adhesive will cure in a reasonable time under the conditions of application without disruptive foaming.

In one embodiment, from about 0.5 to about 1.5 weight percent of 4,4′-dimorpholinodiethylether is in the adhesive when the tertiary amine catalyst is 4,4′-dimorpholinodiethylether, and from about 0.05 to about 0.5 weight percent of bis(2-dimethylaminoethyl)ether is in the adhesive when the tertiary amine catalyst is bis(2-dimethylaminoethyl)ether. When a combination of these two materials is in the adhesive, the amounts are determined as useful for the adhesive in application with the above weight percentages as starting values in empirically determining the best blend according to relative proportions of 4,4′-dimorpholinodiethylether and bis(2-dimethylaminoethyl)ether.

The optional plasticizer is an adipate, a pthalate, a benzoate, a cyclic carbonate, or a combination of these. Benzoyl chloride is optional in some embodiments for stabilizing the adhesive during mixing and storage. In this regard, benzoyl chloride, while stabilizing the formulating adhesive from moisture-induced catalysis, is volatile and corrosive as a raw material (although not volatile and/or corrosive in the formulated product adhesive in the relative proportions used in the final formulations of the product adhesive) and therefore requires appropriate control and handling with respect to industrial hygiene and safety needs of the operating technicians handling the material during adhesive manufacture. Benzoyl chloride inhibitor is, in some embodiments, unnecessary if the process conditions during formulation of the adhesive provide a non-reactive environment as achieved, for example, through use of diligent temperature control and a dry nitrogen purge.

In one embodiment, the polyurethane adhesive base comprises an isocyanate-polyol reaction product prepolymer (polyurethane) as a preferred isocyanate terminated (polyurethane) prepolymer for the adhesive; additives of from about 1.3 to about 6.6 weight percent of 1,2-propanediol cyclic carbonate (plasticizer), from about 0.05 to about 0.4 weight percent of polydimethylsiloxane (defoamer), from about 0.05 to about 0.4 weight percent of benzoyl chloride (inhibitor), and from about 0.5 to about 1.5 weight percent of 4,4′-dimorpholinodiethylether (catalyst) are then mixed into the prepolymer to form the adhesive.

In overview of prepolymer specifics, the isocyanate-polyol reaction product prepolymer has a free NCO percent of from about 10.5 to about 19.6 as reacted from (with weight percentages on the basis of the prepolymer) from about 35 to about 70 weight percent of isocyanate precursor and a remainder of hydroxy terminated polyol precursor. NCO groups provide reactive functional groups with associated isocyanate functionality to the isocyanate precursor when catalyzed with the tertiary amine catalyst. OH groups provide reactive functional groups with associated hydroxyl functionality to the polyol precursor when catalyzed with the tertiary amine catalyst.

The preferred isocyanate precursor is isomeric methylenebis(phenyl isocyanate), polymethylene polyphenylisocyanate (also known as polymeric MDI) having an isocyanate functionality of between 2.1 and 3, or a combination thereof. The preferred hydroxy terminated polyol precursor is hydroxy terminated poly(oxyalkylene)polyol having a hydroxyl functionality of between 2 and 4, polyester polyol having a hydroxyl functionality of between 2 and 3, or a combination thereof.

In further detail, the isocyanate-polyol reaction product prepolymer preferably has a free NCO percent of from about 10.5-19.6 (more preferred, 11-16%) as reacted from, on the basis of the adhesive composition, less than about 38.4 (more preferred from about 22 to about 35) weight percent of isomeric methylenebis(phenyl isocyanate), less than about 40 (more preferred, from about 15-37) weight percent of polymethylene polyphenylisocyanate having an average molecular weight of from about 280 to about 400 (preferred, about 290), less than about 35.4 (more preferred, less than about 32) weight percent of hydroxy terminated poly(oxyalkylene)diol having an average molecular weight range of about 425-4000 (more preferred, 1000-2000) and less than about 45 (more preferred from about 15-40) weight percent of hydroxy terminated poly(oxyalkylene)triol having an average molecular weight range of about 700-4500 (more preferred, 700-1500) and less than about 35 (more preferred, less than 15) weight percent of hydroxy terminated poly(oxyalkylene) quadrol having an average molecular weight range of about 278-568 (more preferred, about 291), and less than about 45 (more preferred from about 15-35) weight percent of hydroxy terminated polyester polyol having an average molecular weight range of about 500-3200 (more preferred, 1000-1500). In these embodiments, the polymethylene polyphenylisocyanate preferably has an average isocyanate reactive functionality of about 2.3, and the hydroxy terminated poly(oxyalkylene)diol, hydroxy terminated poly(oxyalkylene)triol, hydroxy terminated poly(oxyalkylene) quadrol, and/or polyester polyol preferably have an average combined hydroxyl reactive functionality of about 2-4.

The thermal stabilizer particulate additive in some embodiments is from about 0.5 to about 3.4 (most preferred from about 1 to about 1.5) weight percent of surface treated fumed silica particulate (also denoted as silica fume or “fume silica”) having a mean particle size of from about 7 to about 16 nm. In alternative embodiments, the thermal stabilizer particulate additive is from about 0.5 to about 6.5 (most preferred from about 1-2.25) weight percent of calcium carbonate particulate having a mean particle size of about 0.07 to about 0.7 microns. A mixture of the above thermal stabilizers may also be used as long as the minimum amount of at least one of the stabilizers is present.

In one embodiment, the prepolymer is reacted from isomeric methylenebis(phenyl isocyanate), polymethylene polyphenylisocyanate, poly(oxyalkylene)diol, poly(oxyalkylene)triol, and hydroxy terminated poly(oxyalkylene) quadrol at a temperature of from about 135 to about 155 degrees Fahrenheit as sustained for from about 2 to about 3 hours in an essentially inert atmosphere.

Viscosity in the product adhesive is from about 5,000 to about 200,000 centipoises (preferably from about 15,000 to about 20,000 centipoises) at 72 degrees Fahrenheit.

### SYNTHESIS EXAMPLE 1

In one synthesis embodiment, air in a reactor is evacuated and replaced with a charge of nitrogen to provide an essentially moisture-free nitrogen headspace environment at 258.6 mm gauge pressure. The reactor is charged with isomeric methylenebis(phenyl isocyanate), polymethylene polyphenylisocyanate, and 3 weight percentage of 1,2-propanediol cyclic carbonate (plasticizer/diluent) such that the isomeric methylenebis(phenyl isocyanate) is in a weight ratio of about 2.33 to the polymethylene polyphenylisocyanate (polymeric MDI). 1 weight percentage of surface treated fumed silica and 2 weight percentage of calcium carbonate, Ca(CO₃), is added to the reactants. The admixture is agitated for 15 minutes before the reactor is further charged (under mixing) slowly with polyether triol, polyether diol, polydimethylsiloxane defoamer, and benzoyl chloride to provide 30.9 weight percentage of hydroxy terminated poly(oxyalkylene)diol, 15 weight percentage of hydroxy terminated poly(oxyalkylene)triol, 0.2 weight percentage of polydimethylsiloxane, and 0.2 weight percentage of benzoyl chloride in the reactor. While still sustaining mixing, 1 weight percentage of 4,4-dimorpholinodiethylether (DMDEE) is then added. The exotherm from the reaction is used to raise the reactor temperature to 150 degrees Fahrenheit. Mixing of the reactants is sustained at a temperature between 135-155 degrees Fahrenheit at 258.6 mm gauge pressure for 2-3 hours.

The reactants are analyzed to confirm a free NCO percentage of between 11.6 and 13.6 in the polymer of the adhesive product; the reaction is continued until the NCO percentage is within this range.

### SYNTHESIS EXAMPLE 2

In another synthesis embodiment, a pre-blend tank is charged with two different hydroxy terminated poly(oxyalkylene)triols, one at 83.3 weight percent with an average molecular weight of 1500 and the other at 9.6 weight percent with an average molecular weight of 700. Thermal stabilizer particulate of 2.4 weight percentage of surface treated fumed silica and 4.7 weight percentage of calcium carbonate, Ca(CO₃), is added to the polyols. The admixture is agitated at high shear until the silica and calcium carbonate have been incorporated and/or dissolved into the polyols.

Air in a reactor is evacuated and replaced with a charge of nitrogen to provide an essentially moisture-free nitrogen headspace environment at 258.6 mm gauge pressure. The reactor is charged to provide about 39 weight percentage of isomeric methylenebis(phenyl isocyanate) and about 61 weight percentage of polymethylene polyphenylisocyanate in the reactor admixture. The reactor's agitator is activated and, to achieve weight percentages as noted in the following summary, the reactor is further charged slowly first with the polyol pre-blend made in the first step and then with benzoyl chloride and polydimethylsiloxane. The resulting admixture is agitated for 15 minutes before bis(2-dimethylaminoethyl)ether catalyst is added so that the adhesive is fully formulated. In this regard and in summary, a hydroxy terminated poly(oxyalkylene)triol at 35.41 weight percent with an average molecular weight of 1500, a hydroxy terminated poly(oxyalkylene)triol at 4.08 weight percent with an average molecular weight of 700, 1.00 weight percentage of surface treated fumed silica, 2.00 weight percentage of calcium carbonate, 22.11 weight percentage of isomeric methylenebis(phenyl isocyanate), 35.08 weight percentage of polymethylene polyphenylisocyanate, 0.01 weight percentage benzoyl chloride, 0.24 weight percentage of polydimethylsiloxane, and 0.07 weight percentage of bis(2-dimethylaminoethyl)ether catalyst are combined together in the reactor to provide the ingredient basis for the adhesive formulation. The exotherm from the reaction is then used to raise the reactor temperature to 150 degrees Fahrenheit. Mixing of the reactants is sustained at a temperature between 135-155 degrees Fahrenheit and 258.6 mm gauge pressure for 2-3 hours.

The reactants are analyzed to confirm a free NCO percentage of between 13.5-15.5 in the polymer of the adhesive product; the reaction is continued until the NCO percentage is within this range.

The preferred embodiments afford a number of advantages over traditional mortar. In various embodiments, the polyurethane adhesive is delivered to the job site prepackaged with no job site preparation and can be applied in less time than traditional mortar; these features provide savings in labor cost. The adhesive reaches final cure in a shorter period of time than mortar, diminishing overall construction time for masonry construction.

The polyurethane adhesive is useful for joining together masonry made of a plurality of various types of “masonry units”, where a masonry unit can be any of (for example and without limitation) a stone, a brick, a block, a tile, a rock, a pebble, or combinations of these. A masonry unit must provide a bonding surface to which the polyurethane adhesive adheres as it cures; this bonding surface is that portion of the surface area of the masonry unit in contact with the polyurethane adhesive after curing has been completed. While various forms of masonry units are available, concrete block and ceramic brick are more specific types frequently used in construction.

In contemplated masonry embodiments using the polyurethane adhesives described herein, efficacy of the polyurethane adhesive in a masonry joint is enhanced by shaping of at least one of the bonding surfaces of the masonry units. In other contemplated masonry, the efficacy of the polyurethane adhesive in a joint is enhanced by shaping of different bonding surfaces of multiple masonry units shaped to act together in a joint (for example and without limitation, a “tongue and groove” approach between at least two masonry units). In a more specific embodiment of the shaped masonry units, the masonry is constructed of masonry blocks where each masonry block is shaped according to uniform dimensions and uniform surface criteria. Examples of such shaped block approaches are described in U.S. Pat. Nos. 6,226,951; 4,640,071; 4,854,097; 5,575,128; 5,822,939; and 6,134,853.

### PERFORMANCE EXAMPLE 1

Two essentially identical representative polyurethane base adhesive portions are formulated, with the exception of a thermal stabilizer, according to the embodiments as previously described herein in Synthesis Example 2. One of the two portions is further formulated with the addition of an effective amount of thermal stabilizer particulate filler (as previously described herein in Synthesis Example 2). A comparison of structural efficacy according to ASTM E72-95 is made between the two blends (Formulation F denoting the formulation having the thermal stabilizer particulate filler; Formulation NF denoting the formulation not having the thermal stabilizer particulate filler). In the comparison, three sets of concrete masonry unit wall panels (97 and 5/8 inches by 46 and 3/4 inches) are constructed using each adhesive formulation and masonry units of 7.6×7.5×15.6 block having characteristics of a minimum face shell thickness of 1.29 inches, a minimum web thickness of 1.00 inches, 49.7 percent solid, 93.4 pcf density, 14.0 pcf absorption, and 4620 psi net compressive strength. A running bond pattern is used for the construction with a single 1/4 inch bead of adhesive along the face shells of the masonry units. Sufficient adhesive is applied so that, after application, curing, and expansion, the entire face shell joint is covered to form complete joints between all masonry units. All six panels are cured (under mutual bracing) at ambient (60 to 80 degrees Fahrenheit) for 10 days. Testing in accordance with ASTM E 72-95 is then performed to panel rupture using an evenly distributed load (via an air bag system), a manometer to measure applied pressure, a rigid frame to support the wall, and measurements of panel midpoint deflection.

Modulus of rupture data are summarized in Table 1.

TABLE 1

| | Formulation F | Formulation NF |
|---|---|---|
| Ave modulus of | 348.69 | 372.86 |
| rupture (psi) | | |
| Std. Deviation | 42.35 | 29.29 |
| COV | 12.15 | 7.86 |

The results show that, although there is a small diminishment of rupture modulus with the addition of thermal stabilizer particulate filler, the degree of diminishment is very small. Furthermore, the 348 psi measured mean is 5.5 to 5.9 the required bond strength required under The Building Code Requirements For Masonry Structures (ACI 530/ASCE 5; TMS 402) which specifies 63 psi.

### PERFORMANCE EXAMPLE 2

Two essentially identical representative polyurethane base adhesive portions are formulated according to the embodiments as previously described herein, with one sample according to the Formulation NF sample of Performance Example 1 and the second sample according to the Formulation F sample of Performance Example 1 except for 0.01 weight percent of benzoyl chloride (previously discussed herein as optional). A comparison of thermal efficacy is made between the two blends (Formulation F denoting the formulation having the thermal stabilizer particulate filler; Formulation NF denoting the formulation not having the thermal stabilizer particulate filler).

A 2.25 by 3.625 by 7.625-inch construction brick is cut into four equal parts and 10 joints are crafted, with 5 of the joints using Formulation F and 5 joints using Formulation NF. For each joint, a total of 3.0 g of the adhesive is applied on the contacting side of an area measuring 2.25×3.625 inch² on each construction brick part to be used in a joint; the adhesive is then spread to a uniform thickness by use of a tongue depressor. Both treated surfaces are jointed together immediately after the spreading operation; the derived joints are then cured for at least eight hours (“over night”). A direct flame from a Bunsen burner is then applied at and “through” (or “into”) the cured joints for a period of two hours with the joint entry surface being placed approximately 1 inch above the burner. The joints are then cooled for at least eight hours (“over night”). A shear test, to measure the internal cohesive strength of the cured adhesive as well as the adhesion strength between the two substrates, is then performed by using an ATS (Applied Test System, Inc) machine with a crosshead speed of 0.200 inch per minutes.

Upon fracture of the joints under the induced sheer, about ⅔ of the areas of the adhesive joints are noted as completely burned. In this case, the shear values therefore determine the degree to which the remaining bonding characteristics of the joints have been affected by the combination of heat and flame from the Bunsen Burner effected against that portion of the adhesives of the joints that survived the flame treatment. The results of the shear test for five adhesive joints from each filled and non-filled polyurethane adhesives are shown in Table 2.

TABLE 2

| | Formulation | | | |
|---|---|---|---|---|
| | NF | | Formulation F | |
| | Shear load | Cohesive | Shear load | Cohesive |
| Joint # | value, lb | failure, % | value, lb | failure, % |
| 1 | 955 | 55 | 1250 | 20 |
| 2 | 932 | 60 | 1364 | 70 |
| 3 | 1125 | 40 | 1468 | 0 |
| 4 | 1727 | 50 | 2576 | 0 |
| 5 | 2125 | 100 | 2473 | 0 |

A summary of the results from Table 2 is presented in Table 3.

TABLE 3

| Formulation | | | |
|---|---|---|---|
| NF | | Formulation F | |
| Shear load | Adhesive | Shear load | Cohesive |
| value, lb | failure | value, lb | failure |
| 1372 ± 474 | 61% | 1826 ± 575 | 14% |

Since the original adhesive joints are very strong, the strength of the adhesive joint is not specifically determined before burning in this test approach; in this regard, substrate failure precedes adhesive failure in the initial joints, and strength determinations of the adhesive are essentially academic rather than useful to the application. However, respective to pre-burning strength, the results from previously described Performance Example 1 show that a non-filled version of polyurethane adhesive exhibits performance slightly-better-than the performance of filled adhesive. In this thermal test case, it is therefore assumed that adhesive/cohesive strength in a joint having Formulation NF is slightly better than adhesive/cohesive strength in a joint having Formulation F; however, it is to also be noted that, after applying flame to the joint as described above, Formulation NF shows weaker adhesive/cohesive strength respective to Formulation F. The higher percentage of cohesive failure and lower shear load values of Formulation NF joints as compared to Formulation F joints clearly demonstrate the improvement in heat/flame resistance derived from the thermal stabilizer particulate filler.

Furthermore, examination of adhesive color on the opposite sides of the flame-treated joints (the sides of the joints not subjected to direct flame impingement) shows that, when compared to the color of the adhesive at the time of curing and prior to flame treatment, the color of flame treated Formulation NF joint adhesive is slightly yellow (an indication of degradation) but the color of Formulation F joint adhesive remains essentially unchanged. These visual observations also suggest that cured adhesive joints of Formulation F joint adhesive have more resistance to heat and flame than do cured adhesive joints of Formulation NF joint adhesive.

The description of the invention is merely exemplary in nature and, thus, variations that do not depart from the gist of the invention are intended to be within the scope of the invention. Such variations are not to be regarded as a departure from the spirit and scope of the invention.

1. A structural adhesive for masonry, comprising:
(a) a polyurethane adhesive base, said base providing at least 85 weight percent of said structural adhesive at a viscosity sufficient for room temperature bead application of said structural adhesive; and
(b) thermal stabilizer particulate additive dispersed throughout said adhesive base, said particulate additive having a mean particle size sufficient for providing, after application and curing, cured structural adhesive thermal stability in favorable accordance to a predefined threshold.

2. The structural adhesive of claim 1, wherein
(a) said polyurethane adhesive base comprises
(i) isocyanate-polyol reaction product prepolymer having a free NCO percent of from about 10.5 to about 19.6 as reacted from, on the basis of said prepolymer, from about 35 to about 70 weight percent of isocyanate precursor and a remainder of hydroxy terminated polyol precursor wherein said isocyanate precursor is selected from the group consisting of isomeric methylenebis(phenyl isocyanate), polymethylene polyphenylisocyanate having an isocyanate functionality of between 2.1 and 3, and combinations thereof, and wherein said hydroxy terminated polyol precursor is selected from the group consisting of hydroxy terminated poly(oxyalkylene)polyol having a hydroxyl functionality of between 2 and 4, polyester polyol having a hydroxyl functionality of between 2 and 3, and combinations thereof;
(ii) from about 0.05 to about 0.4 weight percent of polydimethylsiloxane defoamer; and
tertiary amine catalyst selected from the group consisting of 4,4′-dimorpholinodiethylether, bis(2-dimethylaminoethyl)ether, and combinations thereof; and
(b) said thermal stabilizer particulate additive comprises surface treated fumed silica particulate having a mean particle size of about 7 to about 16 nm in a quantity of less than 3.4 weight percent of said adhesive composition; and
(ii) calcium carbonate particulate having a mean particle size of about 0.07 to about 0.7 microns in a quantity of less than 6.5 weight percent of said adhesive composition; wherein
(c) said adhesive composition comprises at least 0.5 weight percent of fumed silica particulate in the absence of at least 0.5 weight percent of said calcium carbonate particulate, and
(d) said adhesive composition comprises at least 0.5 weight percent of said calcium carbonate particulate in the absence of at least 0.5 weight percent of said fumed silica particulate.

3. The structural adhesive of claim 2 further comprising from about 1.3 to about 10 weight percent of plasticizer selected from the group consisting of adipates, pthalates, benzoates, cyclic carbonates, and combinations thereof.

4. The structural adhesive of claim 2 wherein from about 0.5 to about 1.5 weight percent of 4,4′-dimorpholinodiethylether is comprised when said tertiary amine catalyst is 4,4′-dimorpholinodiethylether, and from about 0.05 to about 0.5 weight percent of bis(2-dimethylaminoethyl)ether is comprised when said tertiary amine catalyst is bis(2-dimethylaminoethyl)ether.

5. The structural adhesive of claim 2 wherein said prepolymer is reacted from isomeric methylenebis(phenyl isocyanate), polymethylene polyphenylisocyanate, poly(oxyalkylene)diol, and poly(oxyalkylene)triol at a temperature of from about 135 to about 155 degrees Fahrenheit for from about 2 to about 3 hours in an essentially inert atmosphere.

6. The structural adhesive of claim 2 wherein the weight percent of said calcium carbonate particulate is essentially about zero.

7. The structural adhesive of claim 2 wherein the weight percent of said fumed silica particulate is essentially about zero.

8. The structural adhesive of claim 1 wherein said viscosity is from about 5,000 to about 200,000 centipoises at 72 degrees Fahrenheit.

9. The structural adhesive of claim 2 further comprising from about 0.05 to about 0.4 weight percent of benzoyl chloride.

10. An adhesive composition, comprising:
(a) isocyanate-polyol reaction product prepolymer having a free NCO percent of from about 10.5 to about 19.6 as reacted from, on the basis of said prepolymer, from about 35 to about 70 weight percent of isocyanate precursor and a remainder of hydroxy terminated polyol precursor wherein said isocyanate precursor is selected from the group consisting of isomeric methylenebis(phenyl isocyanate), polymethylene polyphenylisocyanate having an isocyanate functionality of between 2.1 and 3, and combinations thereof, and wherein said hydroxy terminated polyol precursor is selected from the group consisting of hydroxy terminated poly(oxyalkylene)polyol having a hydroxyl functionality of between 2 and 4, polyester polyol having a hydroxyl functionality of between 2 and 3, and combinations thereof;
(b) from about 0.05 to about 0.4 weight percent of polydimethylsiloxane defoamer;
(c) tertiary amine catalyst selected from the group consisting of 4,4′-dimorpholinodiethylether, bis(2-dimethylaminoethyl)ether, and combinations thereof;
(d) less than 3.4 weight percent of surface treated fumed silica particulate having a mean particle size of about 7 to about 16 nm; and
(e) less than 6.5 weight percent of calcium carbonate particulate having a mean particle size of about 0.07 to 0.7 microns; wherein
(f) said adhesive composition comprises at least 0.5 weight percent of fumed silica particulate in the absence of at least 0.5 weight percent of said calcium carbonate particulate, and
(g) said adhesive composition comprises at least 0.5 weight percent of said calcium carbonate particulate in the absence of at least 0.5 weight percent of said fumed silica particulate.

11. The adhesive composition of claim 10 further comprising from about 1.3 to about 10 weight percent of plasticizer selected from the group consisting of adipates, pthalates, benzoates, cyclic carbonates, and combinations thereof.

12. The adhesive composition of claim 10 wherein from about 0.5 to about 1.5 weight percent of 4,4′-dimorpholinodiethylether is comprised when said tertiary amine catalyst is 4,4′-dimorpholinodiethylether, and from about 0.05 to about 0.5 weight percent of bis(2-dimethylaminoethyl)ether is comprised when said tertiary amine catalyst is bis(2-dimethylaminoethyl)ether.

13. The adhesive composition of claim 10 wherein said prepolymer is reacted from isomeric methylenebis(phenyl isocyanate), polymethylene polyphenyl isocyanate, poly(oxyal kylene) diol, and poly(oxyalkylene)triol at a temperature of from about 135 to about 155 degrees Fahrenheit for from about 2 to about 3 hours in an essentially inert atmosphere.

14. The adhesive composition of claim 10 wherein the weight percent of said calcium carbonate particulate is essentially about zero.

15. The adhesive composition of claim 10 wherein the weight percent of said fumed silica particulate is essentially about zero.

16. The adhesive composition of claim 10 wherein said adhesive composition has a viscosity of from about 5,000 to about 200,000 centipoises at 72 degrees Fahrenheit.

17. The adhesive composition of claim 10 further comprising from about 0.05 to about 0.4 weight percent of benzoyl chloride.

18. Masonry, comprising:
(a) a plurality of masonry units, each masonry unit having at least one bonding surface, and
(b) cured adhesive positioned to join a bonding surface from one said masonry unit to a bonding surface of another said masonry unit, said cured adhesive cured from an applied adhesive of
(i) isocyanate-polyol reaction product prepolymer having a free NCO percent of from about 10.5 to about 19.6 as reacted from, on the basis of said prepolymer, from about 35 to about 70 weight percent of isocyanate precursor and a remainder of hydroxy terminated polyol precursor wherein said isocyanate precursor is selected from the group consisting of isomeric methylenebis(phenyl isocyanate), polymethylene polyphenylisocyanate having an isocyanate functionality of between 2.1 and 3, and combinations thereof, and wherein said hydroxy terminated polyol precursor is selected from the group consisting of hydroxy terminated poly(oxyalkylene)polyol having a hydroxyl functionality of between 2 and 4, polyester polyol having a hydroxyl functionality of between 2 and 3, and combinations thereof;
(ii) from about 0.05 to about 0.4 weight percent of polydimethylsiloxane defoamer;
(iii) tertiary amine catalyst selected from the group consisting of 4,4′-dimorpholinodiethylether, bis(2-dimethylaminoethyl)ether, and combinations thereof;
(iv) less than 3.4 weight percent of surface treated fumed silica particulate having a mean particle size of about 7 to about 16 nm; and
(v) less than 6.5 weight percent of calcium carbonate particulate having a mean particle size of about 0.07 to about 0.7 microns; wherein (vi) said applied adhesive comprises at least 0.5 weight percent of fumed silica particulate in the absence of at least 0.5 weight percent of said calcium carbonate particulate, and
(vii) said applied adhesive comprises at least 0.5 weight percent of said calcium carbonate particulate in the absence of at least 0.5 weight percent of said fumed silica particulate.

19. The masonry of claim 18 wherein said applied adhesive further comprises from about 1.3 to about 10 weight percent of plasticizer selected from the group consisting of adipates, pthalates, benzoates, cyclic carbonates, and combinations thereof.

20. The masonry of claim 18 wherein from about 0.5 to about 1.5 weight percent of 4,4′-dimorpholinodiethylether is in said adhesive when said tertiary amine catalyst is 4,4′-dimorpholinodiethylether, and from about 0.05 to about 0.5 weight percent of bis(2-dimethylaminoethyl)ether is in said adhesive when said tertiary amine catalyst is bis(2-dimethylaminoethyl)ether.

21. The masonry of claim 18 wherein said prepolymer is reacted from isomeric methylenebis(phenyl isocyanate), polymethylene polyphenylisocyanate, poly(oxyalkylene)diol, and poly(oxyalkylene)triol at a temperature of from about 135 to about 155 degrees Fahrenheit for from about 2 to about 3 hours in an essentially inert atmosphere.

22. The masonry of claim 18 wherein the weight percent of said calcium carbonate particulate is essentially about zero.

23. The masonry of claim 18 wherein the weight percent of said fumed silica particulate is essentially about zero.

24. The masonry of claim 18 wherein said applied adhesive has a viscosity of from about 5,000 to about 200,000 centipoises at 72 degrees Fahrenheit.

25. The masonry of claim 18 wherein any said masonry unit is selected from the group of masonry units consisting of a stone, a brick, a block, a tile, a rock, a pebble, and combinations thereof.

26. The masonry of claim 18 wherein said applied adhesive is applied on any said bonding surface as a daubing of from about 0.065 to about 0.750 inches in thickness.

27. A method for making an adhesive composition, comprising:
(a) reacting together
from about 35 to about 70 weight percent of isocyanate precursor selected from the group consisting of isomeric methylenebis(phenyl isocyanate), polymethylene polyphenylisocyanate having an isocyanate functionality of between 2.1 and 3, and combinations thereof, and
a remainder of hydroxy terminated polyol precursor selected from the group consisting of hydroxy terminated poly(oxyalkylene)polyol having a hydroxyl functionality of between 2 and 4, polyester polyol having a hydroxyl functionality of between 2 and 3, and combinations thereof so that a isocyanate-polyol reaction product prepolymer having a free NCO percent of from about 10.5 to about 19.6 is formed; and
(b) forming an adhesive by mixing together, proportionate to said adhesive,
(i) said isocyanate-polyol reaction product prepolymer,
(ii) from about 0.05 to about 0.4 weight percent of polydimethylsiloxane defoamer,
(iii) tertiary amine catalyst selected from the group consisting of 4,4′-dimorpholinodiethylether, bis(2-dimethylaminoethyl)ether, and combinations thereof,
(iv) less than 3.4 weight percent of surface treated fumed silica particulate having a mean particle size of about 7 to about 16 nm, and
(v) less than 6.5 weight percent of calcium carbonate particulate having a mean particle size of about 0.07 to about 0.7 microns, wherein
(vi) said adhesive comprises at least 0.5 weight percent of fumed silica particulate in the absence of at least 0.5 weight percent of said calcium carbonate particulate, and
(vii) said adhesive comprises at least 0.5 weight percent of said calcium carbonate particulate in the absence of at least 0.5 weight percent of said fumed silica particulate.

28. The method of claim 27 where said forming further comprises mixing into said adhesive from about 1.3 to about 10 weight percent of plasticizer selected from the group consisting of adipates, pthalates, benzoates, cyclic carbonates, and combinations thereof.

29. The method of claim 27 wherein from about 0.5 to about 1.5 weight percent of 4,4′-dimorpholinodiethylether is mixed in said forming when said tertiary amine catalyst is 4,4′-dimorpholinodiethylether, and from about 0.05 to about 0.5 weight percent of bis(2-dimethylaminoethyl)ether is mixed in said forming when said tertiary amine catalyst is bis(2-dimethylaminoethyl)ether.

30. The method of claim 27 wherein said reacting together is sustained for from about 2 to about 3 hours at a temperature of from about 135 to about 155 degrees Fahrenheit in an essentially inert atmosphere.

31. The method of claim 27 wherein the weight percent of said calcium carbonate particulate is essentially about zero.

32. The method of claim 27 wherein the weight percent of said fumed silica particulate is essentially about zero.

33. The method of claim 27 wherein said adhesive has a viscosity of from about 5,000 to about 200,000 centipoises at 72 degrees Fahrenheit.

34. Adhesive made by a process according to the method of claim 27.

35. A method for constructing masonry, comprising:
(a) reacting together
(i) from about 35 to about 70 weight percent of isocyanate precursor selected from the group consisting of isomeric methylenebis(phenyl isocyanate), polymethylene polyphenylisocyanate having an isocyanate functionality of between 2.1 and 3, and combinations thereof, and
(ii) a remainder of hydroxy terminated polyol precursor selected from the group consisting of hydroxy terminated poly(oxyalkylene)polyol having a hydroxyl functionality of between 2 and 4, polyester polyol having a hydroxyl functionality of between 2 and 3, and combinations thereof so that a isocyanate-polyol reaction product prepolymer having a free NCO percent of from about 10.5 to about 19.6 is formed; and
(b) forming an adhesive by mixing together, proportionate to said adhesive,
(i) said isocyanate-polyol reaction product prepolymer,
(ii) from about 0.05 to about 0.4 weight percent of polydimethylsiloxane defoamer,
(iii) tertiary amine catalyst selected from the group consisting of 4,4′-dimorpholinodiethylether, bis(2-dimethylaminoethyl)ether, and combinations thereof,
(iv) less than 3.4 weight percent of surface treated fumed silica particulate having a mean particle size of about 7 to about 16 nm, and
(v) less than 6.5 weight percent of calcium carbonate particulate having a mean particle size of about 0.07 to about 0.7 microns, wherein (vi) said adhesive comprises at least 0.5 weight percent of fumed silica particulate in the absence of at least 0.5 weight percent of said calcium carbonate particulate, and
(vii) said adhesive comprises at least 0.5 weight percent of said calcium carbonate particulate in the absence of at least 0.5 weight percent of said fumed silica particulate;
(c) providing a plurality of masonry units, each masonry unit having at least one bonding surface;
(d) adhering said masonry units together by joining the bonding surfaces together with said adhesive; and
(e) curing said adhesive.

36. The method of claim 35 where said forming further comprises mixing into said adhesive from about 1.3 to about 10 weight percent of plasticizer selected from the group consisting of adipates, pthalates, benzoates, cyclic carbonates, and combinations thereof.

37. The method of claim 35 wherein from about 0.5 to about 1.5 weight percent of 4,4′-dimorpholinodiethylether is mixed in said forming when said tertiary amine catalyst is 4,4′-dimorpholinodiethylether, and from about 0.05 to about 0.5 weight percent of bis(2-dimethylaminoethyl)ether is mixed in said forming when said tertiary amine catalyst is bis(2-dimethylaminoethyl)ether.

38. The method of claim 35 wherein said reacting together is sustained for from about 2 to about 3 hours at a temperature of from about 135 to about 155 degrees Fahrenheit in an essentially inert atmosphere.

39. The method of claim 35 wherein the weight percent of said calcium carbonate particulate is essentially about zero.

40. The method of claim 35 wherein the weight percent of said fumed silica particulate is essentially about zero.

41. The method of claim 35 wherein said applied adhesive has a viscosity of from about 5,000 to about 200,000 centipoises at 72 degrees Fahrenheit.

42. The method of claim 35 wherein any said masonry unit is selected from the group of masonry units consisting of a stone, a brick, a block, a tile, a rock, a pebble, and combinations thereof.

43. The method of claim 35 wherein said adhering comprises applying a daubing of from about 0.065 to about 0.750 inches in thickness of said adhesive to one said bonding surface.

44. Masonry constructed by a process, comprising:
(a) reacting together
(i) from about 35 to about 70 weight percent of isocyanate precursor selected from the group consisting of isomeric methylenebis(phenyl isocyanate), polymethylene polyphenylisocyanate having an isocyanate functionality of between 2.1 and 3, and combinations thereof, and
(ii) a remainder of hydroxy terminated polyol precursor selected from the group consisting of hydroxy terminated poly(oxyalkylene)polyol having a hydroxyl functionality of between 2 and 4, polyester polyol having a hydroxyl functionality of between 2 and 3, and combinations thereof so that a isocyanate-polyol reaction product prepolymer having a free NCO percent of from about 10.5 to about 19.6 is formed;
(b) forming an adhesive by mixing together, proportionate to said adhesive,
(i) said isocyanate-polyol reaction product prepolymer,
(ii) from about 0.05 to about 0.4 weight percent of polydimethylsiloxane defoamer,
(iii) tertiary amine catalyst selected from the group consisting of 4,4′-dimorpholinodiethylether, bis(2-dimethylaminoethyl)ether, and combinations thereof,
(iv) less than 3.4 weight percent of surface treated fumed silica particulate having a mean particle size of about 7 to about 16 nm, and
(v) less than 6.5 weight percent of calcium carbonate particulate having a mean particle size of about 0.07 to about 0.7 microns, wherein
(vi) said adhesive comprises at least 0.5 weight percent of fumed silica particulate in the absence of at least 0.5 weight percent of said calcium carbonate particulate, and
(vii) said adhesive comprises at least 0.5 weight percent of said calcium carbonate particulate in the absence of at least 0.5 weight percent of said fumed silica particulate;
(c) providing a plurality of masonry units, each masonry unit having at least one bonding surface;
(d) adhering said masonry units together by joining the bonding surfaces together with said adhesive; and
(e) curing said adhesive.

45. The masonry of claim 44 where said forming further comprises mixing into said adhesive from about 1.3 to about 10 weight percent of plasticizer selected from the group consisting of adipates, pthalates, benzoates, cyclic carbonates, and combinations thereof.

46. The masonry of claim 44 wherein from about 0.5 to about 1.5 weight percent of 4,4′-dimorpholinodiethylether is mixed in said forming when said tertiary amine catalyst is 4,4′-dimorpholinodiethylether, and from about 0.05 to about 0.5 weight percent of bis(2-dimethylaminoethyl)ether is mixed in said forming when said tertiary amine catalyst is bis(2-dimethylaminoethyl)ether.

47. The masonry of claim 44 wherein said reacting together is sustained for from about 2 to about 3 hours at a temperature of from about 135 to about 155 degrees Fahrenheit in an essentially inert atmosphere.

48. The masonry of claim 44 wherein the weight percent of said calcium carbonate particulate is essentially about zero.

49. The masonry of claim 44 wherein the weight percent of said fumed silica particulate is essentially about zero.

50. The masonry of claim 44 wherein said applied adhesive has a viscosity of from about 5,000 to about 200,000 centipoises at 72 degrees Fahrenheit.

51. The masonry of claim 44 wherein any said masonry unit is selected from the group of masonry units consisting of a stone, a brick, a block, a tile, a rock, a pebble, and combinations thereof.

52. The masonry of claim 44 wherein said adhering comprises applying a daubing of from about 0.065 to about 0.750 inches in thickness of said adhesive to one said bonding surface.

53. A structural adhesive comprising:
(a) isocyanate terminated polyurethane prepolymer, said prepolymer having a free NCO percent of from about 10.5 to about 19.6; and
(b) thermal stabilizer particulate additive of
(i) less than 3.4 weight percent of surface treated fumed silica particulate having a mean particle size of about 7 to about 16 nm, and
(ii) less than 6.5 weight percent of calcium carbonate particulate having a mean particle size of about 0.07 to about 0.7 microns, wherein
(iii) said adhesive comprises at least 0.5 weight percent of fumed silica particulate in the absence of at least 0.5 weight percent of said calcium carbonate particulate, and
(iv) said adhesive comprises at least 0.5 weight percent of said calcium carbonate particulate in the absence of at least 0.5 weight percent of said fumed silica particulate.
